(19) United States
(12) Patent Application Publication
(10) Pub. No.: US 2009/0180459 A1
(43) Pub. Date: Jul. 16, 2009

(54) OFDMA Frame Structures for Uplinks in MIMO Networks

(76) Inventors: Philip V. Orlik, Cambridge, MA (US); Andreas F. Molisch, Arlington, MA (US); Zhifeng Tao, Allston, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/240,164

(22) Filed: Sep. 29, 2008

Related U.S. Application Data
(60) Provisional application No. 61/021,366, filed on Jan. 16, 2008.

(51) Int. Cl. H04B 7/208; H04L 27/28

(52) U.S. Cl. 370/344; 375/260

(57) ABSTRACT

A method communicates symbols in a cell of a multiple-input multiple-output (MIMO) network that includes a set of mobile station and a base station. The symbols are communicated using orthogonal frequency division multiplexing (OFDM) and time division duplex (TDM). A frame for communicating the symbols between the base station and the mobile station is constructed. The frame is partitioned into a downlink subframe and an uplink subframe. The uplink subframe is partitioned into a first zone and a second zone, wherein the first zone uses orthogonal frequency division multiple access (OFDMA) and the second zone uses single carrier frequency division multiple access (SC-FDMA).

### RELATED APPLICATION

This Application claims priority to U.S. Provisional Patent Application 61/021,366, “OFDMA Frame Structures for Enabling Single Carrier Uplink in Wireless Communication Networks, filed by Orlik et al. on 16 Jan. 2008.

### FIELD OF THE INVENTION

This invention relates generally to the field of wireless communications, and more particularly to the uplink transmission in cellular communication networks from user terminals to base stations, and more particularly to single carrier multiple-input multiple-output (MIMO) orthogonal frequency division multiplexing (OFDM), and MIMO-orthogonal frequency division multiple access (OFDMA) schemes.

### BACKGROUND OF THE INVENTION

The IEEE 802.16 standard “Part 1.6: Air interface for Broadband Wireless Access Systems” 802.16, upon which WiMAX is based, employs orthogonal frequency demultiplexing multiple access (OFDMA) in an uplink from a user terminal to a base station. In OFDMA, each user terminal (transceiver or mobile station) sends data to the base station on a set of assigned sub-carriers on which the transmitter modulates data symbols. Multiple access among several terminals is achieved by allocating disjoint sets of sub-carriers to the terminals. Thus, each uplink OFDMA symbol contains data from several mobile stations on disjoint sets of sub-carriers.

FIG. 1B shows a conventional OFDMA transmitter and receiver. This structure is currently used in networks designed according to the IEEE 802.16 standard. The transmitter starts by grouping complex valued modulation symbols 101 {xₙ}, n=0, 1, 2, . . . , N. The grouped modulation symbols are mapped and modulated 100 to N of M orthogonal subcarriers via an M-point inverse discrete Fourier transform (IDFT) operation 110.

The input to the inverse discrete Fourier transform (IDFT) block 110 is a set of M complex valued symbols, of which M-N are zero. The remaining M-N sub-carriers are used by other mobile stations. This signal processing is conventional for OFDM transmission and includes adding a cyclic prefix (CP) 120, and then converting (DAC) 130 the baseband digital signal to analog radio frequency signals, 130, amplifying and transmitting over a wireless channel 135.

At the receiver, the received RF signal is converted (ADC) 140 to baseband and sampled to generate a baseband digital signal. The digital signal is processed to remove 150 the cyclic prefix, and then converted back to the frequency domain via an M-point DFT 160. The signal is equalized 170 to mitigate the effects of the wireless channel, and the individual user data can be separated by de-mapping the sub-carriers, i.e., detecting 180 the data on N sub-carriers associated with particular users.

An alternative, but similar transmission technique, is called single carrier frequency division multiple access (SC-FDMA). This technique is currently under consideration for use in the uplink of 3GPP, “3rd Generation Partnership Project; Technical Specification Group Radio Access Network; Physical layer aspects for evolved Universal Terrestrial Radio Access (UTRA),” Release 7. SC-FDMA is described in detail by H. G. Myung et al. in “Single Carrier FDMA for Uplink Wireless Transmission,” IEEE Vehicular Technology Magazine, September 2006, pp. 30-38.

FIG. 2 shows a conventional SC-FDMA transmitter and receiver. This is essentially, the same structure as in FIG. 1B, except for the presence of an additional N-point discrete Fourier transform (DFT) 290 in the transmitter, and an N-point IDFT 291 in the receiver. The DFT 290 spreads the user data over all the N assigned sub-carriers of the OFDM symbol. In contrast, in the OFDMA transmitter of FIG. 1B, each individual data symbol xₙ is carried on a single sub-carrier according to the M-point IDFT.

The descriptions of the OFDMA and SC-FDMA techniques show the similarities between the two techniques. Both OFDMA and SC-FDMA transmit a sequence of OFDM symbols, where the individual sub-carriers are assigned to multiple user terminals. In both cases, the transmitted signal can be thought of as a two dimensional signal occupying both the time and frequency domains.

Regulatory domains, e.g., governmental agencies, such as the FCC in the U.S or the ETSI in Europe, may place restrictions on the type of wireless technologies used in the RF spectrums. Additionally, market acceptance of competing standards, e.g., WiMAX or 3GPP LTE, may further partition the wireless spectrum into areas where one service provider supports either OFDMA or SC-FDMA.

Therefore, it is desired to deploy both transmission techniques within the same cellular network.

### SUMMARY OF THE INVENTION

The invention provides a method for combining OFDMA with SC-FDMA in a wireless network.

### BRIEF DESCRIPTION OF THE DRAWINGS

FIG. 1A is a schematic of a wireless network used by embodiments of the invention;

FIG. 1B is a block diagram of a conventional OFDMA transceiver;

FIG. 2 is a block diagram of a conventional SC-FDMA transceiver;

FIG. 3 is a block diagram of a conventional frame structure;

FIG. 4 is a block diagram of frame structures according to embodiments of the invention;

FIGS. 5-6 are block diagrams of SC-FDMA sub-carrier mappings according to embodiments of the invention;

FIG. 7 is a block diagram of frame structures according to embodiments of the invention; and

FIG. 8 is a block diagram of a SC-FDMA transceiver according one embodiment of the invention.

### DETAILED DESCRIPTION OF THE PREFERRED EMBODIMENTS

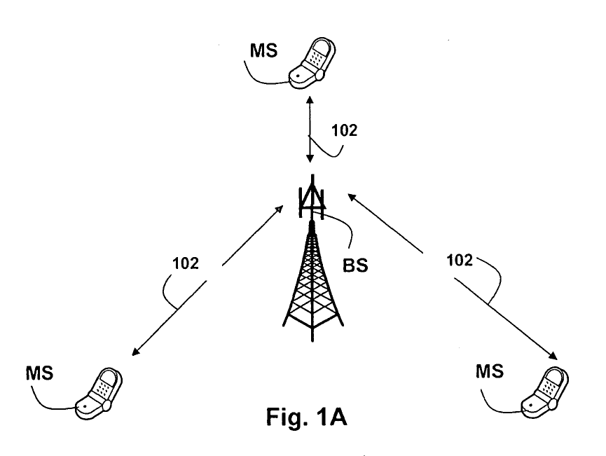

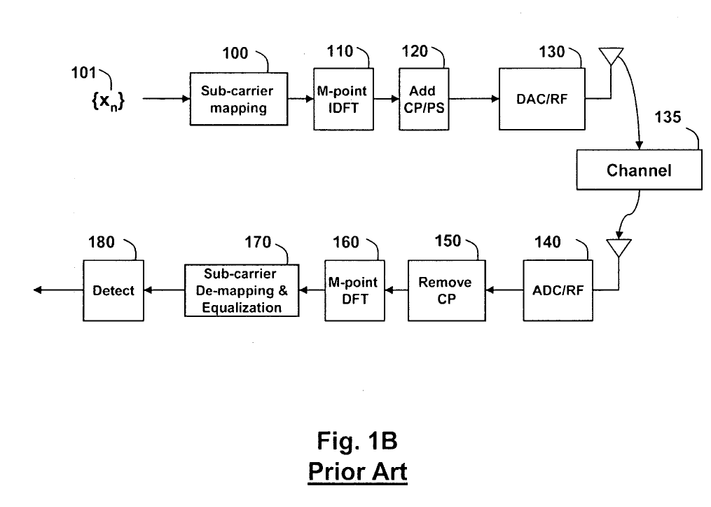

FIG. 1A shows a cellular network used by embodiments of the invention, e.g., a wireless network according to the IEEE 802.16/16e standard. The network includes a base station (BS), and mobile stations (MS). Each station includes a transmitter and a receiver, i.e., a transceiver, as described below. The BS manages and coordinates all communications with the MS in a particular cell over channels.

The network as shown is different in that the stations and channels support both orthogonal frequency division multiple access (OFDMA), and single carrier frequency division multiple access (SC-FDMA) on uplink and downlink channels 102.

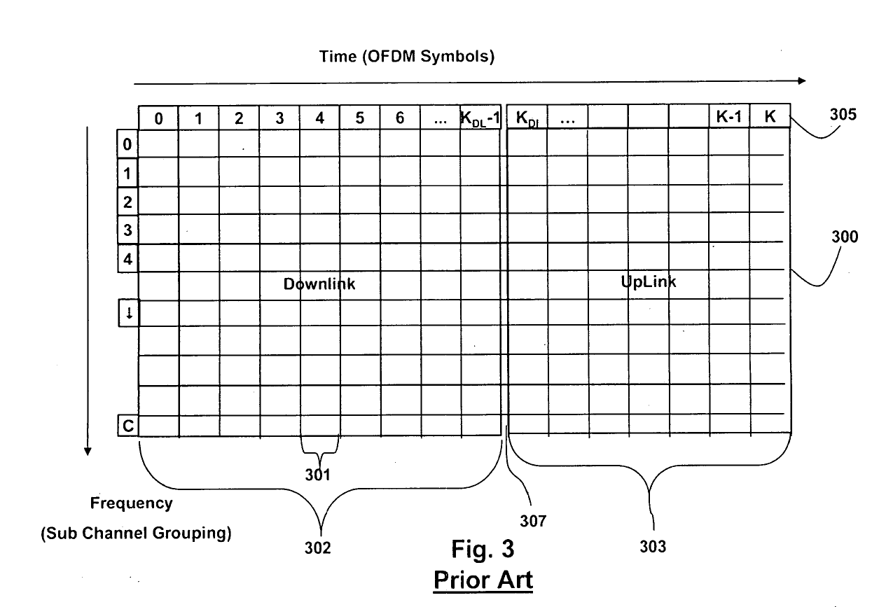

FIG. 3 shows a conventional frame structure used in cellular network only using OFDM. The horizontal axis indicates time, and the vertical axis indicates frequency sub-channel groupings. A frame 300 is defined as a group of time consecutive K+1 OFDM symbols 305, where the OFDM symbols are indexed from 0 to K. Each OFDM symbol uses a set of C+1 parallel orthogonal frequency sub-channels indexed from 0 to C. Thus, a single column 301 of the time-frequency plane shown in FIG. 3 is a single OFDM symbol.

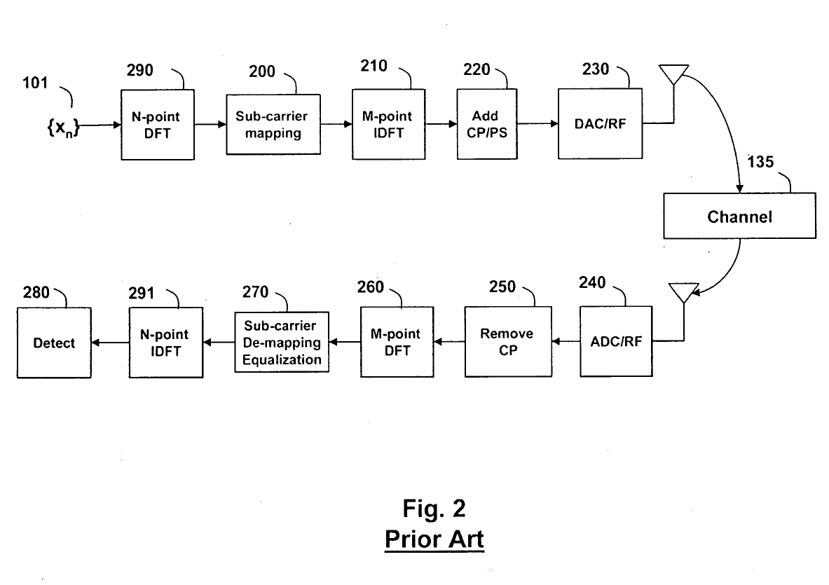

The sub-channels may represent individual sub-carriers of the OFDM network, in this case C=M, i.e., the size of the IDFT in FIGS. 1B and 2. Alternatively, a group of sub-carriers can be assigned for a particular transmission. The latter is the case in the IEEE 802.16 standard. In any event, the definition of a frame as a group of consecutive OFDM symbols holds.

In a time division duplex (TDD) network, the OFDM symbols are further partitioned into an uplink subframe 302, and a downlink subframe 303. In general, the first K_{DL} symbols are allocated for downlink transmission from a base station to terminals, while the remaining K-K_{DL} symbols are allocated for uplink transmissions from the terminals to the base station.

A small time gap 307 between the (K_{DL}−1)^{th} symbol and (K_{DL})^{th} symbol may be needed, in order to allow the terminals sufficient time to switch between transmit and receive modes. A time gap between two consecutive frames may also be needed for similar reason.

It is assumed that the downlink subframe also contains a certain number of OFDM control symbols that are reserved for broadcasting control information. Typically, the base station transmits control information including, sub-channel assignments, and schedule information for the remainder of the downlink and uplink subframes to its associated terminals using these OFDM control symbols.

A majority of recent wireless cellular standards have adopted OFDMA transmission. We focus on the uplink subframe. As described above, both OFDMA and SC-FDMA have essentially the same signal structure based on OFDM, with the only difference being that SC-FDMA performs additional frequency spreading across the sub-carriers.

Therefore, the base station can be modified to either directly detect data after the sub-carrier demapping and equalization 170, or to perform an additional despreading 291.

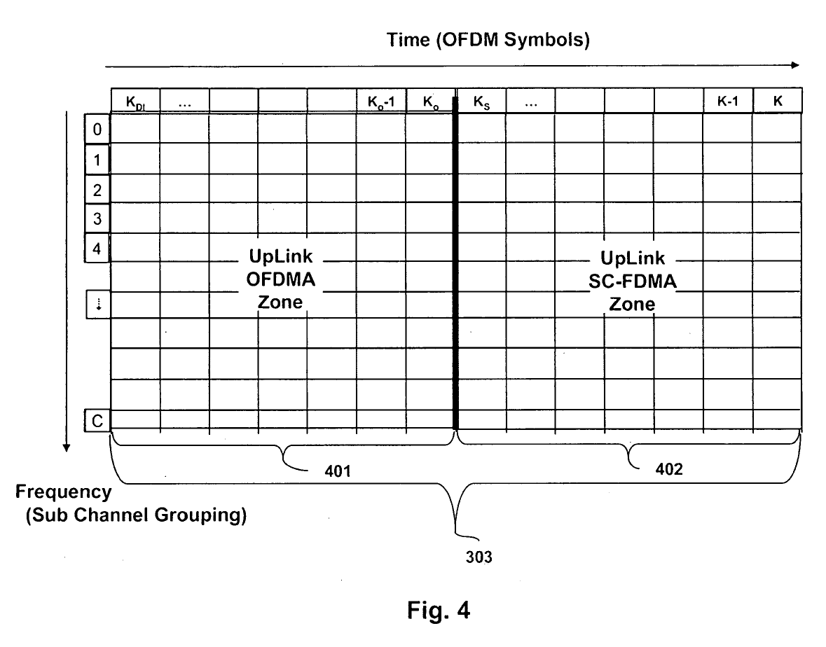

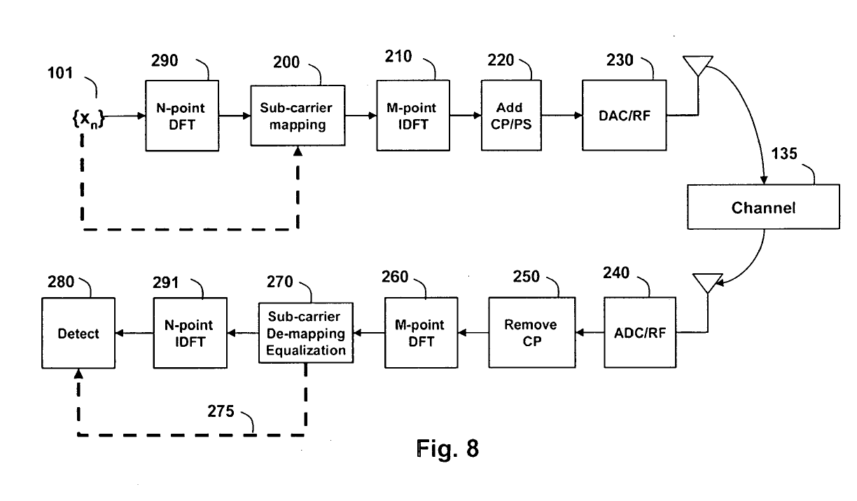

We modify the uplink portion of the frame structure as shown in FIGS. 4 and 8 to enable the base station to support both OFDMA and SC-FDMA mobile stations in the same cell.

FIG. 4 shows a modified uplink frame structure 303 according to an embodiment of the invention. The uplink subframe has been partitioned into two portions, or zones 401-402. Zones are defined generally in the IEEE 802.16 standard.

According to the embodiments of the invention, a first zone 401 is used exclusively for OFDMA transmission from mobile terminals, and a second zone 402 is used exclusively for SC-FDMA transmissions from the mobile terminals.

The arrangement, i.e., the ordering of the OFDMA and SC-FDMA zone, and their relative sizes, i.e., number of constituent OFDM symbols, can be arbitrary. The capabilities of the terminals, with respect to OFDMA and SC-FDMA, are typically exchanged with the base station during the network entry, re-entry and hand over when a mobile station changes cells. The base station can allocate the size of the zones based on the number of terminals that are capable of the respective OFDMA and SC-FDMA transmission.

The K-K_{DL} symbols that make-up the entire uplink subframe can be partitioned by specifying an indexed of a starting symbol and a length or number of consecutive symbols. The starting symbol index for the OFDMA zone 401 is denoted as K_{Oi} and its length, in units of OFDM symbols) is denoted K_{OI}.

Likewise for the SC-OFDMA zone 402, K_{Si}, K_{Si} denote the starting symbol index and zone length respectively. The values of the K_{Oi}, K_{OI}, K_{Si}, K_{Si} are variable and can be determined by the base station on a frame-by-frame basis. The determination can be based on the number of terminals that support OFDMA or SC-FDMA, and the amount of traffic generated by the various terminals. After the variables K_{Oi}, K_{OI}, K_{Si}, K_{Si} are determined, the control symbols for the variables are transmitted to terminals during the broadcast of control information in a downlink subframe.

Sub-Carrier Mapping Considerations

As an advantage, SC-FDMA has a lower peak to average power ratio (PAPR) than OFDMA. This enables the mobile station to extend its transmission range. This reduction in PAPR does come with some constraints in the way that sub-carrier mapping is performed. Therefore, within the SC-OFDMA zone 402, sub-carrier mapping is done in such a way as to achieve a reduction in PAPR. We described two approaches to this mapping. One is termed interleaved, and the other is termed contiguous.

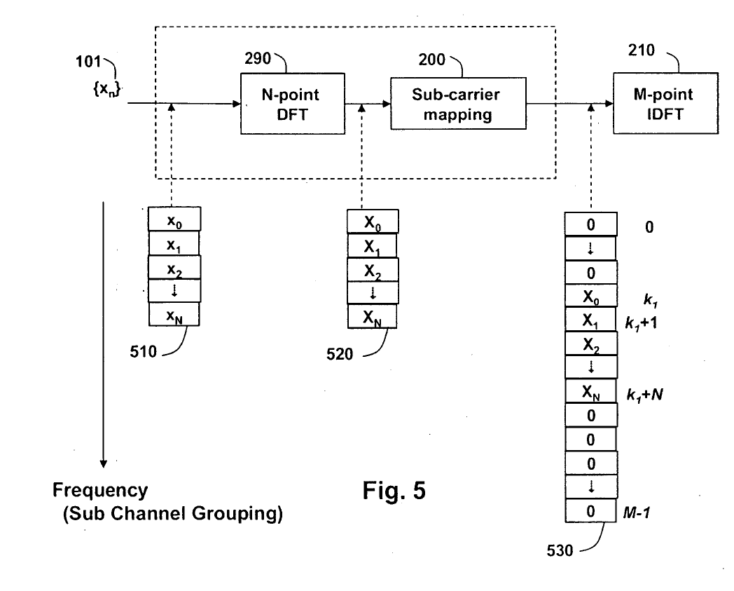

FIG. 5 shows a sequence of symbols {xₙ} 510 and the N-point DFT 290 and the sub-carrier mapping 200. At the output of the N-Point DFT, we have N frequency symbols 520 that can be mapped onto M sub-carriers. In contiguous mapping, the sequence xₙ, {n=0, 1, . . . , N−1} is mapped to a set of sub-carriers indexed by k, which is a sequence of N consecutive integers {k=k₁, k₁+1, k₁+2, . . . , k₁+N} 530. The remaining M-N inputs of the M-Point IDTF are set to zero, and thus can be assigned to other terminals in the network.

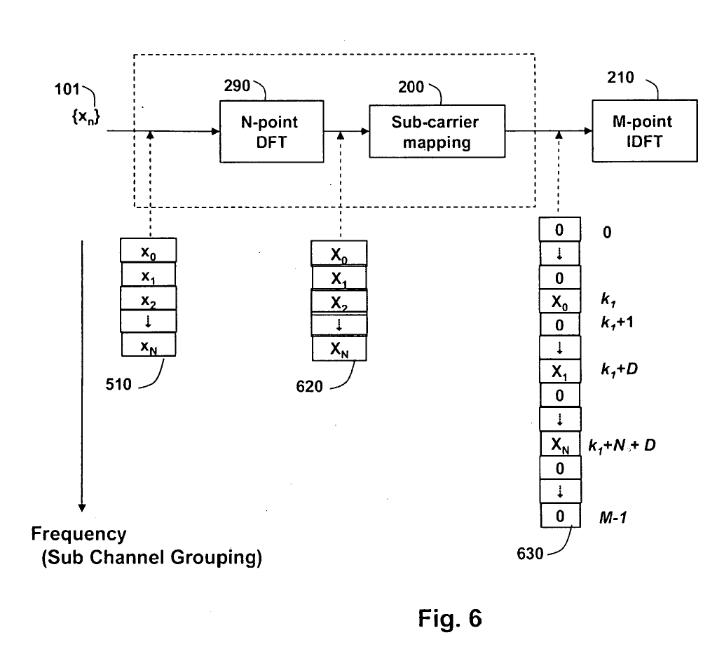

FIG. 6 shows an example of the interleaved mapping. In this case, the N outputs 620 from the DFT block 290, are mapped to a non-contiguous set of sub carriers 630 indexed by {k=k₁, k₁+D, k₁+2*D, . . . k₁+N+D}, where D is a fixed number that represents the spacing between allocated sub-carriers. Thus, the input to the M-point IDFT 210 includes regularly spaced non-zero inputs. The remaining terminals can be assigned to the M-N carriers, which results in an interleaving of user data over the sub-carriers.

The most efficient use of the M sub-carriers results when N is an integer divisor of M. Thus, we can assign all M sub-carriers to

$$\frac{M}{N} = U$$

terminals. In this case, the interleaved mapping leads to D=U.

SC-FDMA with N=M

In one embodiment, a frame structure can be considered for SC-FDMA uplink transmission when N=M. In this case, the sizes of the DFT and IDFT are the same and we can view this as a frequency spreading case in which data from the terminal is spread over the entire bandwidth of an OFDM symbol. Multiple access in this case is not achieved by assigning sub-carriers within a single OFDM symbol because an entire symbol is used by each user terminal. Rather the base station assigns transmission slots to each terminal, wherein each slot is a single OFDM symbol with M subcarriers all carrying data for one terminal.

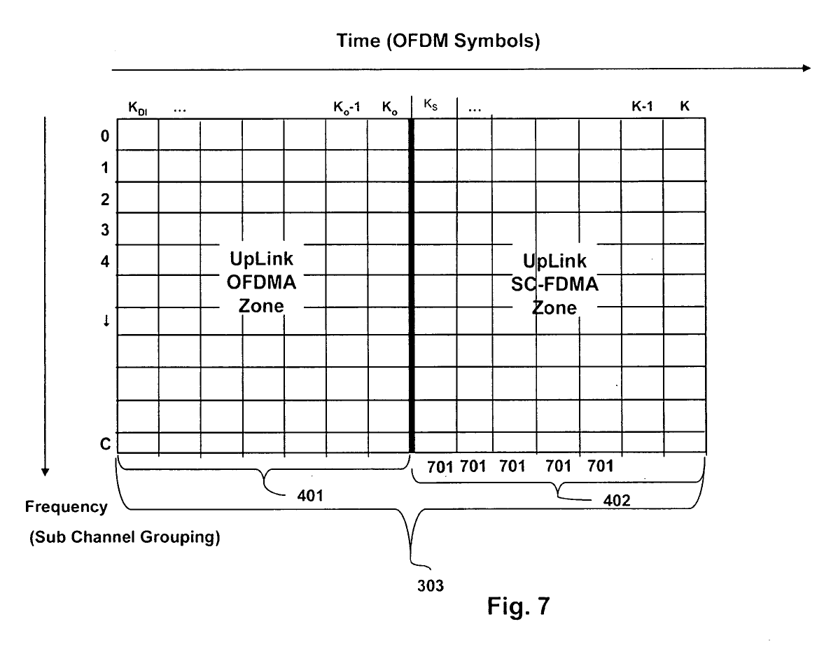

FIG. 7 shows the uplink subframe 303 with this multiple access scheme. The subframe is partitioned into the OFDMA zone 401 and the SC-FDMA zone 402. In the SC-FDMA zone 402, the base station assigns entire column of OFDM symbols 701, i.e., all subcarriers, to a terminal and the terminal spread their data according to FIG. 2.

This technique has two benefits. First, it achieves a minimal PAPR for all schemes. Second, terminals are able to reduce power because the terminal can transmit at much higher data rates compared to the other multiple access and mapping techniques.

In addition, a terminal can compress all of its transmission into a minimal amount of time, and then enter a sleep or idle state, which consumes less power, while the terminal waits for the next downlink or uplink subframe.

Per Terminal SC-FDMA

The above described embodiments all partition the uplink subframe 303, where SC-FDMA transmissions are segregated from OFDMA transmissions. This segregation is not strictly necessary for the coexistence of OFDMA and SC-FDMA in the same cell.

As shown in FIGS. 1B and 2, the only difference between the two transmission schemes is the extra step of spreading data with the DFT 290 in the case of SC-FDMA. The SC-FDMA receiver despread with the IDFT operation 291.

Thus, as shown in FIG. 8, the base station can serve both OFDMA and SC-FDMA terminals within a single zone by selectively spreading and despreading sub-carriers that are assigned to SC-FDMA terminals. That, in the case of OFDMA the spreading and despreading is by-passed 275, as shown by the dashed lines.

Because the base station is responsible for allocating sub-carriers and symbols to terminals, the BS can select to despread via an additional IDFT. During the transmission of the broadcast control information at the beginning of the downlink subframe, the base-station signals the individual terminals that they should implement an N-point DFT spreading operation of their data over their assigned sub-carries.

The signal can be a single bit that is transmitted along with the set of sub-carriers and the OFDM symbol indices. A value of ‘1’ indicates to the terminal that SC-FDMA spreading is active for uplink transmission, while a value of ‘0’ indicates that OFDMA transmission is to be used. This signaling procedure assumes that the base station has knowledge regarding the capabilities of the terminal, i.e., whether or not it is capable of SC-FDMA transmission.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for communicating symbols in a cell of a multiple-input multiple-output (MIMO) network including a set of mobile station and a base station, wherein the symbols are communicated using orthogonal frequency division multiplexing (OFDM) and time division duplex (TDM), comprising the steps of:
constructing a frame for communicating the symbols between the base station and the mobile station, wherein the frame is partitioned into a downlink subframe for communicating the symbols from the base station to the mobile station, and an uplink subframe for communicating the symbols from the mobile station to the base station;
partitioning the uplink subframe into a first zone and a second zone, wherein the first zone uses orthogonal frequency division multiple access (OFDMA) and the second zone uses single carrier frequency division multiple access (SC-FDMA); and
transmitting the uplink subframe from the mobile station to the base station.

2. The method of claim 1, wherein the set of mobile station in the cell concurrently communicate with the base station using both the OFDMA of the first zone and the SC-FDMA of the second zone.

3. The method of FIG. 1, wherein a transmitter of a particular mobile station selectively performs a discrete Fourier transform (DFT) to spread symbols over sub-carriers for the SC-FDMA.

4. The method of claim 1, wherein an arrangement of the first zone and the second zone is arbitrary.

5. The method of claim 4, wherein the arrangement is determined by the base station.

6. The method of claim 4, wherein the arrangement depends on a number of the set of mobile station operating in the OFDMA and SC-FDMA mode.

7. The method of claim 4, wherein the arrangement of the zones is specified by a an index of a starting symbol and a number of consecutive symbols in each zone.

8. The method of claim 7, further comprising:
broadcasting the index and length as control symbols in the downlink subframe.

9. The method of claim 1, further comprising:
mappings the symbols to contiguous sub-carriers in the second zone.

10. The method of claim 1, further comprising:
interleaving the symbols among sub-carriers in the second zone.

11. The method of 1, wherein an entire column of symbols are assigned to a single mobile station.
